(19) United States
(12) Patent Application Publication
(10) Pub. No.: US 2024/0171965 A1
(43) Pub. Date: May 23, 2024

(54) Modem System Selection Optimization in WLAN-Only Mode

(71) Applicant: QUALCOMM Incorporated, San Diego, CA (US)

(72) Inventors: Dhatchaini RAJENDRAN, San Diego, CA (US); Qin Xue FRANTTI, San Diego, CA (US); Gurpreet GREWAL, San Diego, CA (US); Osama LOTFALLAH, San Diego, CA (US); Vinay PARADKAR, Broomfield, CO (US); Tze Kwan LAU, San Diego, CA (US); Reza SHAHIDI, La Jolla, CA (US); Flora Pui San CHAN, San Diego, CA (US); Vikram SINGH, San Diego, CA (US)

(21) Appl. No.: 18/058,627

(22) Filed: Nov. 23, 2022

(51) Int. Cl. H04W 8/22; H04W 4/90

(52) U.S. Cl. CPC H04W 8/22; H04W 4/90; H04W 88/06

(57) ABSTRACT

Various embodiments include methods performed by a processor of a computing device for managing Radio Access Technology (RAT) capability during a Wireless Local Area Network (WLAN)-only mode. Various embodiments may include determining whether the computing device is in a WLAN-only mode, and removing circuit-switched RATs from the RAT capability of the computing device in response to determining that the computing device is in the WLAN-only mode. This determination may be made during system bootup of the computing device, upon detecting the change in the WLAN settings and/or based on a notification message from a multimedia subsystem indicating that the computing device is in the WLAN-only mode. Some embodiments may further include transmitting a service request with only packet-switched (PS) RATs included in a RAT priority list to a Non-Access Stratum (NAS) layer of the computing device, in which the PS RATs include Long Term Evolution (LTE) and New Radio (NR).

### BACKGROUND

A computing device (e.g., user operating a user equipment (UE)) within a telecommunications network may set preferences to transmit and receive wireless data according to one or more telecommunications standards or protocols. A user may set preferences to prioritize one or more Radio Access Technologies (RATs) including 2G, 3GPP Long Term Evolution, LTE, 3G, 4G, 5G (e.g., NR), Global System for Mobile Communications (GSM), Code Division Multiple Access (CDMA), Wideband CDMA (WCDMA), Worldwide Interoperability for Microwave Access (WiMAX), Time Division Multiple Access (TDMA), and other mobile telephony communication technologies cellular RATs. A user may also set a RAT preference of their computing device to Wi-Fi, in which communicating wireless data across Wi-Fi is preferred over other RATs.

### SUMMARY

Various aspects include methods executable by a computing device (e.g., a UE) for managing Radio Access Technology (RAT) capability during a Wireless Local Area Network (WLAN)-only mode. Various aspects may include determining whether the computing device is in a WLAN-only mode, and removing circuit-switched (CS) RATs from the RAT capability of the computing device in response to determining that the computing device is in the WLAN-only mode. In some embodiments, determining whether the computing device is in the WLAN-only mode further may include determining whether the computing device is in the WLAN-only mode during system bootup of the computing device. In some embodiments, determining whether the computing device is in the WLAN-only mode further may include detecting a change in WLAN settings of the computing device, and determining whether the computing device is in the WLAN-only mode in response to detecting the change in the WLAN settings. In some embodiments, determining whether the computing device is in the WLAN-only mode may include receiving a notification message from an Intellectual Property Multimedia Subsystem (multimedia subsystem) of the computing device indicating that the computing device is in the WLAN-only mode.

Some embodiments may further include transmitting a service request with only packet-switched (PS) RATs included in a RAT priority list to a Non-Access Stratum (NAS) layer of the computing device, in which the PS RATs include Long Term Evolution (LTE) and New Radio (NR). Some embodiments may further include determining whether the computing device is in an emergency mode indicating that an emergency call has been initialized, and adding the CS RATs to the RAT capability in response to determining that the computing device is in the emergency mode. Some embodiments may further include determining whether the computing device lost a communication link with subscription wireless communication service, and adding the CS RATs to the RAT capability in response to determining that the computing device lost a communication link with subscription wireless communication service.

Further aspects include a computing device (e.g., a UE) including a processor configured to perform operations of any of the methods summarized above. Further aspects include a computing device including means for performing functions of any of the methods summarized above. Further aspects include a non-transitory processor-readable medium having stored thereon processor-executable instructions configured to cause a processor of a UE to perform operations of any of the methods summarized above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1A is a system block diagram illustrating an example communication system suitable for implementing any of the various embodiments.

FIG. 1B is a system block diagram illustrating an example disaggregated base station architecture for wireless communication systems suitable for implementing any of the various embodiments.

FIG. 2 is a component block diagram illustrating an example computing device and wireless modem system suitable for implementing any of the various embodiments.

FIG. 3 is a component block diagram illustrating a software architecture including a radio protocol stack for the user and control planes in wireless communications suitable for implementing any of the various embodiments.

FIG. 4 is a component block diagram illustrating an example system for managing system faults according to some embodiments.

FIG. 5 is a message flow diagram illustrating operations for improving modem system selection in Wireless Local Area Network (WLAN)-only mode according to some embodiments.

FIG. 6A is a process flow diagram of an example method 600a for managing Radio Access Technology (RAT) capability of a computing device during a WLAN-only mode in accordance with various embodiments.

FIGS. 6B-6D are process flow diagrams of example operations 600b-600d that may be performed as part of the method 600a for managing RAT capability of a computing device during a WLAN-only mode in in accordance with some embodiments.

FIG. 7 is a component block diagram illustrating an example computing device suitable for use with the various embodiments.

FIG. 8 is a component block diagram illustrating an example wireless communication device suitable for use with the various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods and devices for managing Radio Access Technology (RAT) capability of a modem of a computing device (e.g., a UE) during a Wireless Local Area Network (WLAN)-only mode. For example, a user may configure a UE computing device to prefer Wi-Fi wireless communications (i.e., WLAN-only mode) within a telecommunications network over other wireless communications standards. Various embodiments may include determining whether the computing device is in a WLAN-only mode, and removing circuit-switched (CS) RATs from an RAT capability of the computing device in response to determining that the computing device is in the WLAN-only mode.

The terms “computing device” and “wireless computing device” used interchangeably herein to refer to electronic devices that include a memory, wireless communication components and a programmable processor. Non-limiting examples of computing devices include any one or all of various computing devices, UEs, wireless devices, cellular telephones, smartphones, portable computing devices, personal or mobile multi-media players, laptop computers, tablet computers, smartbooks, ultrabooks, palmtop computers, smart glasses, extended reality (XR) devices, wireless electronic mail receivers, multimedia Internet-enabled cellular telephones, medical devices and equipment, biometric sensors/devices, wearable devices including smart watches, smart clothing, smart wrist bands, smart jewelry (for example, smart rings and smart bracelets), entertainment devices (for example, wireless gaming controllers, music and video players, satellite radios, etc.), wireless-network enabled Internet of Things (IoT) devices including smart meters/sensors, industrial manufacturing equipment, large and small machinery and appliances for home or enterprise use, wireless communication elements within autonomous and semiautonomous vehicles, wireless computing devices affixed to or incorporated into various mobile platforms, global positioning system devices, and the like.

The term “system-on-a-chip” (SoC) is used herein to refer to a single integrated circuit (IC) chip that contains multiple resources and/or processors integrated on a single substrate. A single SoC may contain circuitry for digital, analog, mixed-signal, and radio-frequency functions. A single SoC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SoCs may also include software for controlling the integrated resources and processors, as well as for controlling peripheral devices.

The term “system-in-a-package” (SIP) may be used herein to refer to a single module or package that contains multiple resources, computational units, cores and/or processors on two or more IC chips, substrates, or SoCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SoCs coupled together via high-speed communication circuitry and packaged in close proximity, such as on a single motherboard or in a single wireless computing device. The proximity of the SoCs facilitates high speed communications and the sharing of memory and resources.

As used herein, the terms “network,” “system,” “wireless network,” “cellular network,” and “wireless communication network” may interchangeably refer to a portion or all of a wireless network of a carrier associated with a wireless computing device and/or subscription on a wireless computing device. The techniques described herein may be used for various wireless communication networks, such as Code Division Multiple Access (CDMA), time division multiple access (TDMA), FDMA, orthogonal FDMA (OFDMA), single carrier FDMA (SC-FDMA) and other networks. In general, any number of wireless networks may be deployed in a given geographic area. Each wireless network may support at least one radio access technology, which may operate on one or more frequency or range of frequencies. For example, a CDMA network may implement Universal Terrestrial Radio Access (UTRA) (including Wideband Code Division Multiple Access (WCDMA) standards), CDMA2000 (including IS-2000, IS-95 and/or IS-856 standards), etc. In another example, a TDMA network may implement Global System for Mobile Communications (GSM) Enhanced Data rates for GSM Evolution (EDGE). In another example, an OFDMA network may implement Evolved UTRA (E-UTRA), IEEE 802.11 (Wi-Fi), IEEE 802.16 (WiMAX), IEEE 802.20, Flash-OFDM®, etc. Reference may be made to wireless networks that use Long Term Evolution (LTE) standards, and therefore the terms “Evolved Universal Terrestrial Radio Access,” “E-UTRAN” and “eNodeB” may also be used interchangeably herein to refer to a wireless network. However, such references are provided merely as examples, and are not intended to exclude wireless networks that use other communication standards. For example, while various Third Generation (3G) systems, Fourth Generation (4G) systems, and Fifth Generation (5G) systems are discussed herein, those systems are referenced merely as examples and future generation systems (e.g., sixth generation (6G) or higher systems) may be substituted in various embodiments.

A computing device (e.g., a smartphone UE) within a telecommunications network may be configured by a user to prefer communicating via Wi-Fi connections and access points over other RATs, such as GSM, CDMA, WCDMA, LTE, and any other RATs that would otherwise conventionally be implemented by default instead of Wi-Fi. Setting a preference to communicate telecommunications network data via Wi-Fi connection(s) may allow a user to directly control which RATs and associated wireless networks will be used for communicating data. Thus, a user may configure a computing device to have a preference to communicate via a local, potentially faster Wi-Fi connection while avoiding using RATs associated with potentially slow and/or intermittent networks that may otherwise be the default communication protocol. For example, a computing device may be configured with a preference to use Wi-Fi to connect to a Wireless Local Area Network (WLAN) that does not charge for communication services over other RATs to avoid using telecommunications networks that charge for communicating data. As another example, a computing device may be configured with a preference to implement Wi-Fi over other RATs to avoid issues associated with weak RAT signals and wireless connections that can drain battery power of the computing device due to frequent searching for better signals and reestablishing communication sessions.

When a Wireless Local Area Network (WLAN) (e.g., C_IWLAN as sometimes referred to in software code) feature is enabled on a computing device and a WLAN RAT preference is set to Wi-Fi, the computing device is considered to be in a WLAN-only mode. In a WLAN-only mode, a multimedia subsystem of the computing device may only communicate via a WLAN or Wi-Fi connection. Therefore, Wireless Wide Area Networks (WWANs) may not be valid (i.e., usable) RATs when configuring a computing device to be in a WLAN-only mode.

Even if a computing device is configured in a WLAN-only mode, the computing device may continue to search for available RATs during system selection (i.e., to “camp” on a network access point), including available WWANs, despite those WWANs being invalid communication methods during the WLAN-only mode. These additional searching processes may increase power demands draining battery power of the computing device, may contribute to overheating of the computing device, and may cause the computing device to take longer to determine an available, secure, and preferred wireless connection. Additionally, the unnecessary searching for available but invalid wireless wide area network (WWAN) connections during a WLAN-only mode may contribute to a user incurring roaming charges under a telecommunications service subscription.

Various embodiments improve the WLAN-only mode by excluding from the computing device RAT capability circuit-switched (CS) RATs, such as GSM, CDMA, and Wideband Code Division Multiple Access (WCDMA). Various embodiments eliminate extraneous processes of searching for CS RATs during a WLAN-only mode, thereby minimizing the number of operations performed during system selection, conserving energy stored in a battery, and avoiding computing device roaming. In some embodiments, packet-switched (PS) RATs, such as LTE or New Radio, which support WLAN-only mode, may be retained during implementation of a WLAN-only mode while CS RATs are excluded.

For example, a modem of a computing device (e.g., cellular phone) may determine whether the computing device is configured in a WLAN-only mode on power up and/or each time a WLAN setting is changed by the high-level operating system (HLOS). If the computing device is in a WLAN-only mode, the modem may exclude the CS RATs from the computing device RAT capability and system selection for all use cases except while the computing device is in an emergency mode (e.g., during a 911 call initiation/session) or in full RAT mode (i.e., default mode). In some embodiments, the CS RATs may be added back into the computing device RAT capability list under certain conditions, such as when an emergency call is originated while in WLAN-only mode, the computing device enters full RAT mode in WLAN-only mode, the computing device loses subscription while in WLAN-only mode, and/or and the computing device is configured (i.e., by the user) to exit WLAN-only mode and enter full RAT mode.

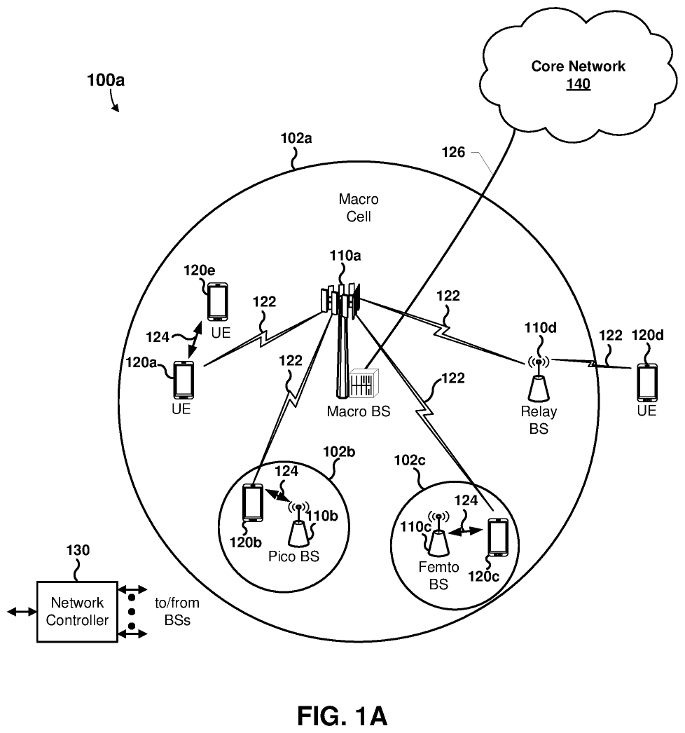

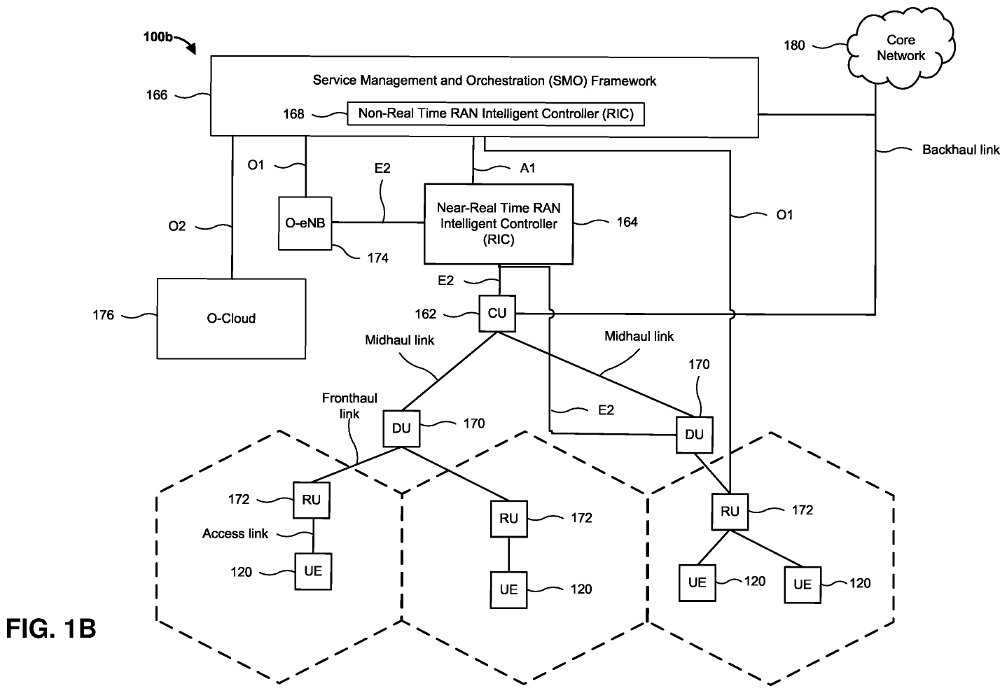

FIG. 1A is a system block diagram illustrating an example communication system 100a suitable for implementing any of the various embodiments. The communications system 100a may be a 5G New Radio (NR) network, or any other suitable network such as an LTE network, 5G network, etc. While FIG. 1 illustrates a 5G network, later generation networks may include the same or similar elements. Therefore, the reference to a 5G network and 5G network elements in the following descriptions is for illustrative purposes and is not intended to be limiting.

The communications system 100a may include a heterogeneous network architecture that includes a core network 140 and a variety of mobile devices (illustrated as wireless computing devices 120a-120e in FIG. 1). The communications system 100a may also include a number of base stations (illustrated as the BS 110a, the BS 110b, the BS 110c, and the BS 110d) and other network entities. A base station is an entity that communicates with wireless computing devices, and also may be referred to as a Node B, an LTE Evolved nodeB (eNodeB or eNB), an access point (AP), a Radio head, a transmit receive point (TRP), a New Radio base station (NR BS), a 5G NodeB (NB), a Next Generation NodeB (gNodeB or gNB), or the like. Each base station may provide communication coverage for a particular geographic area. In 3GPP, the term “cell” can refer to a coverage area of a base station, a base station Subsystem serving this coverage area, or a combination thereof, depending on the context in which the term is used. The core network 140 may be any type of core network, such as an LTE core network (e.g., an Evolved Packet Core (EPC) network), 5G core network, etc.

A base station 110a-110d may provide communication coverage for a macro cell, a pico cell, a femto cell, another type of cell, or a combination thereof. A macro cell may cover a relatively large geographic area (for example, several kilometers in radius) and may allow unrestricted access by mobile devices with service subscription. A pico cell may cover a relatively small geographic area and may allow unrestricted access by mobile devices with service subscription. A femto cell may cover a relatively small geographic area (for example, a home) and may allow restricted access by mobile devices having association with the femto cell (for example, mobile devices in a closed subscriber group (CSG)). A base station for a macro cell may be referred to as a macro BS. A base station for a pico cell may be referred to as a pico BS. A base station for a femto cell may be referred to as a femto BS or a home BS. In the example illustrated in FIG. 1, a base station 110a may be a macro BS for a macro cell 102a, a base station 110b may be a pico BS for a pico cell 102b, and a base station 110c may be a femto BS for a femto cell 102c. A base station 110a-110d may support one or multiple (for example, three) cells. The terms “eNB”, “base station”, “NR BS”, “gNB”, “TRP”, “AP”, “node B”, “5G NB”, and “cell” may be used interchangeably herein.

In some examples, a cell may not be stationary, and the geographic area of the cell may move according to the location of a mobile base station. In some examples, the base stations 110a-110d may be interconnected to one another as well as to one or more other base stations or network nodes (not illustrated) in the communications system 100a through various types of backhaul interfaces, such as a direct physical connection, a virtual network, or a combination thereof using any suitable transport network.

The base station 110a-110d may communicate with the core network 140 over a wired or wireless communication link 126. The wireless computing devices 120a-120e may communicate with the base station 110a-110d over a wireless communication link 122.

The wired communication link 126 may use a variety of wired networks (e.g., Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100a also may include relay stations (e.g., relay BS 110d). A relay station is an entity that can receive a transmission of data from an upstream station (for example, a base station or a mobile device) and transmit the data to a downstream station (for example, a wireless computing device or a base station). A relay station also may be a mobile device that can relay transmissions for other wireless computing devices. In the example illustrated in FIG. 1, a relay station 110d may communicate with macro the base station 110a and the wireless computing device 120d in order to facilitate communication between the base station 110a and the wireless computing device 120d. A relay station also may be referred to as a relay base station, a relay base station, a relay, etc.

The communications system 100a may be a heterogeneous network that includes base stations of different types, for example, macro base stations, pico base stations, femto base stations, relay base stations, etc. These different types of base stations may have different transmit power levels, different coverage areas, and different impacts on interference in communications system 100a. For example, macro base stations may have a high transmit power level (for example, 5 to 40 Watts) whereas pico base stations, femto base stations, and relay base stations may have lower transmit power levels (for example, 0.1 to 2 Watts).

A network controller 130 may couple to a set of base stations and may provide coordination and control for these base stations. The network controller 130 may communicate with the base stations via a backhaul. The base stations also may communicate with one another, for example, directly or indirectly via a wireless or wireline backhaul.

The wireless computing devices 120a, 120b, 120c may be dispersed throughout communications system 100a, and each wireless computing device may be stationary or mobile. A wireless computing device also may be referred to as an access terminal, a terminal, a mobile station, a subscriber unit, a station, UE, etc.

A macro base station 110a may communicate with the communication network 140 over a wired or wireless communication link 126. The wireless computing devices 120a, 120b, 120c may communicate with a base station 110a-110d over a wireless communication link 122.

The wireless communication links 122, 124 may include a plurality of carrier signals, frequencies, or frequency bands, each of which may include a plurality of logical channels. The wireless communication links 122 and 124 may utilize one or more Radio access technologies (RATs). Examples of RATs that may be used in a wireless communication link include 3GPP LTE, 3G, 4G, 5G (e.g., NR), GSM, CDMA, WCDMA, Worldwide Interoperability for Microwave Access (WiMAX), Time Division Multiple Access (TDMA), and other mobile telephony communication technologies cellular RATs. Further examples of RATs that may be used in one or more of the various wireless communication links 122, 124 within the communication system 100a include medium range protocols such as Wi-Fi, LTE-U, LTE-Direct, LAA, MuLTEfire, and relatively short-range RATs such as ZigBee, Bluetooth, and Bluetooth Low Energy (LE).

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum Resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz (i.e., 6 Resource blocks), and there may be 1, 2, 4, 8 or 16 subbands for system bandwidth of 1.25, 2.5, 5, 10 or 20 MHz, respectively.

While descriptions of some embodiments may use terminology and examples associated with LTE technologies, some embodiments may be applicable to other wireless communications systems, such as a new Radio (NR) or 5G network. NR may utilize OFDM with a cyclic prefix (CP) on the uplink (UL) and downlink (DL) and include support for half-duplex operation using time division duplex (TDD). A single component carrier bandwidth of 100 MHz may be supported. NR Resource blocks may span 12 sub-carriers with a sub-carrier bandwidth of 75 kHz over a 0.1 millisecond (ms) duration. Each Radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. Beamforming may be supported and beam direction may be dynamically configured. Multiple Input Multiple Output (MIMO) transmissions with precoding may also be supported. MIMO configurations in the DL may support up to eight transmit antennas with multi-layer DL transmissions up to eight streams and up to two streams per wireless computing device. Multi-layer transmissions with up to 2 streams per wireless computing device may be supported. Aggregation of multiple cells may be supported with up to eight serving cells. Alternatively, NR may support a different air interface, other than an OFDM-based air interface.

Some mobile devices may be considered machine-type communication (MTC) or Evolved or enhanced machine-type communication (eMTC) mobile devices. MTC and eMTC mobile devices include, for example, robots, remote devices, sensors, meters, monitors, location tags, etc., that may communicate with a base station, another device (for example, remote device), or some other entity. A wireless node may provide, for example, connectivity for or to a network (for example, a wide area network such as Internet or a cellular network) via a wired or wireless communication link. Some mobile devices may be considered Internet-of-Things (IoT) devices or may be implemented as NB-IoT (narrowband internet of things) devices. A wireless computing devices 120a-120e may be included inside a housing that houses components of the wireless computing device, such as processor components, memory components, similar components, or a combination thereof.

In general, any number of communication systems and any number of wireless networks may be deployed in a given geographic area. Each communications system and wireless network may support a particular Radio access technology (RAT) and may operate on one or more frequencies. A RAT also may be referred to as a Radio technology, an air interface, etc. A frequency also may be referred to as a carrier, a frequency channel, etc. Each frequency may support a single RAT in a given geographic area in order to avoid interference between communications systems of different RATs. In some cases, 4G/LTE and/or 5G/NR RAT networks may be deployed. For example, a 5G non-standalone (NSA) network may utilize both 4G/LTE RAT in the 4G/LTE RAN side of the 5G NSA network and 5G/NR RAT in the 5G/NR RAN side of the 5G NSA network. The 4G/LTE RAN and the 5G/NR RAN may both connect to one another and a 4G/LTE core network (e.g., an evolved packet core (EPC) network) in a 5G NSA network. Other example network configurations may include a 5G standalone (SA) network in which a 5G/NR RAN connects to a 5G core network.

In some embodiments, two or more wireless computing devices 120a-120e (for example, illustrated as the wireless computing device 120a and the wireless computing device 120e) may communicate directly using one or more sidelink channels 124 (for example, without using a base station 110a-110d as an intermediary to communicate with one another). For example, wireless computing devices 120a-120e may communicate using peer-to-peer (P2P) communications, device-to-device (D2D) communications, a vehicle-to-everything (V2X) protocol (which may include a vehicle-to-vehicle (V2V) protocol, a vehicle-to-infrastructure (V2I) protocol, or similar protocol), a mesh network, or similar networks, or combinations thereof. In this case, the wireless computing devices 120a-120e may perform scheduling operations, resource selection operations, as well as other operations described elsewhere herein as being performed by the base station 110a.

The wireless computing devices 120a-120e may be configured to monitor channel conditions and report the channel conditions to the base station 110a-110d. For example, a channel condition may be indicated in channel state information (CSI) reported by the wireless computing devices 120a-120e to the base station 110a-110d. CSI reported by the wireless computing devices 120a-120e may include a channel quality indicator (CQI) index value indicated in a channel state feedback (CSF) report sent from the wireless computing devices 120a-120e to the base station 110a-110d. CSI may be reported by the wireless computing devices 120a-120e to the base station 110a-110d physical uplink control channel (PUCCH) or physical uplink shared channel (PUSCH). CQI index values may be observed or estimated channel measurements sent by the wireless computing devices 120a-120e to the base station 110a-110d as an index value to indicate channel quality. CQI index values may be integer values, such as values 0-15, that indicate the quality of the DL channel as observed or estimated by the wireless computing devices 120a-120e.

The base station 110a-110d may be configured to select wireless computing devices 120a-120e to receive broadcast packets based on channel quality estimates, such as based on channel conditions reported by the wireless computing devices 120a-120e in CSI reported by the wireless computing devices 120a-120e. CQI index values may be used by the base station 110a-110d to determine a modulation and coding scheme (MCS) value for a wireless computing devices 120a-120e. A base station 110a-110d may construct an MCS pool containing the union of all MCS values determined from the CSI reports from the wireless computing devices 120a-120e in the cell. During rate control operations the base station 110a-110d may select a minimum MCS value to cover a percentage of the MCS pool, such as 25%, 50%, 100%, and select wireless computing devices 120a-120e having an MCS at or above the minimum MCS value to receive broadcast packets. Wireless devices 120a-120e having an MCS below the minimum MCS value may not be selected to receive broadcast packets.

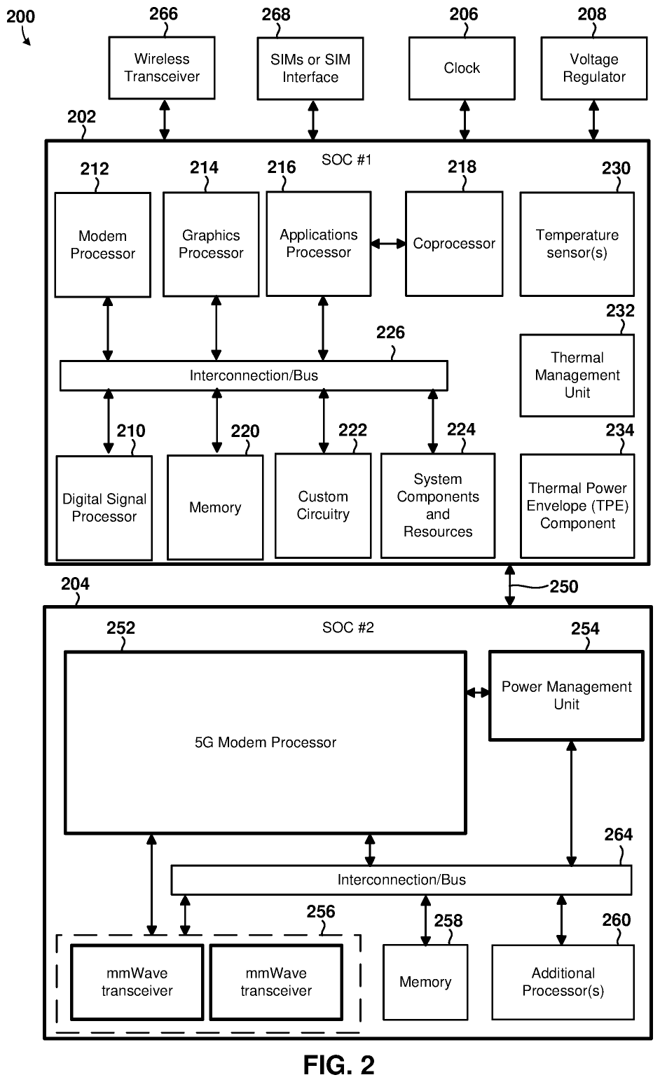

FIG. 1B is a system block diagram 100b illustrating an example disaggregated base station 160 architecture that may be part of a 5G network suitable for managing system faults. With reference to FIGS. 1 and 2, the disaggregated base station 160 architecture may include one or more central units (CUs) 162 that can communicate directly with a core network 180 via a backhaul link, or indirectly with the core network 180 through one or more disaggregated base station units, such as a Near-Real Time (Near-RT) RAN Intelligent Controller (RIC) 164 via an E2 link, or a Non-Real Time (Non-RT) RIC 168 associated with a Service Management and Orchestration (SMO) Framework 166, or both. A CU 162 may communicate with one or more distributed units (DUs) 170 via respective midhaul links, such as an F1 interface. The DUs 170 may communicate with one or more radio units (RUs) 172 via respective fronthaul links. The RUs 172 may communicate with respective computing devices 120 via one or more radio frequency (RF) access links. In some implementations, a computing device, such as a vehicle safety system 104, may be simultaneously served by multiple RUs 172.

Each of the units (i.e., CUs 162, DUs 170, RUs 172), as well as the Near-RT RICs 164, the Non-RT RICs 168 and the SMO Framework 166, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 162 may host one or more higher layer control functions. Such control functions may include the radio resource control (RRC), packet data convergence protocol (PDCP), service data adaptation protocol (SDAP), or the like. Each control function may be implemented with an interface configured to communicate signals with other control functions hosted by the CU 162. The CU 162 may be configured to handle user plane functionality (i.e., Central Unit-User Plane (CU-UP)), control plane functionality (i.e., Central Unit-Control Plane (CU-CP)), or a combination thereof. In some implementations, the CU 162 can be logically split into one or more CU-UP units and one or more CU-CP units. The CU-UP unit can communicate bidirectionally with the CU-CP unit via an interface, such as the E1 interface when implemented in an O-RAN configuration. The CU 162 can be implemented to communicate with DUs 170, as necessary, for network control and signaling.

The DU 170 may correspond to a logical unit that includes one or more base station functions to control the operation of one or more RUs 172. In some aspects, the DU 170 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 170 may further host one or more low PHY layers. Each layer (or module) may be implemented with an interface configured to communicate signals with other layers (and modules) hosted by the DU 170, or with the control functions hosted by the CU 162.

Lower-layer functionality may be implemented by one or more RUs 172. In some deployments, an RU 172, controlled by a DU 170, may correspond to a logical node that hosts RF processing functions, or low-PHY layer functions (such as performing fast Fourier transform (FFT), inverse FFT (iFFT), digital beamforming, physical random-access channel (PRACH) extraction and filtering, or the like), or both, based at least in part on the functional split, such as a lower layer functional split. In such an architecture, the RU(s) 172 may be implemented to handle over the air (OTA) communication with one or more computing devices 120. In some implementations, real-time and non-real-time aspects of control and user plane communication with the RU(s) 172 may be controlled by the corresponding DU 170. In some scenarios, this configuration may enable the DU(s) 170 and the CU 162 to be implemented in a cloud-based radio access network (RAN) architecture, such as a vRAN architecture.

The SMO Framework 166 may be configured to support RAN deployment and provisioning of non-virtualized and virtualized network elements. For non-virtualized network elements, the SMO Framework 166 may be configured to support the deployment of dedicated physical resources for RAN coverage requirements, which may be managed via an operations and maintenance interface (such as an O1 interface). For virtualized network elements, the SMO Framework 166 may be configured to interact with a cloud computing platform (such as an open cloud (O-Cloud) 176) to perform network element life cycle management (such as to instantiate virtualized network elements) via a cloud computing platform interface (such as an O2 interface). Such virtualized network elements can include, but are not limited to, CUs 162, DUs 170, RUs 172 and Near-RT RICs 164. In some implementations, the SMO Framework 166 may communicate with a hardware aspect of a 4G RAN, such as an open eNB (O-eNB) 174, via an O1 interface. Additionally, in some implementations, the SMO Framework 166 may communicate directly with one or more RUs 172 via an O1 interface. The SMO Framework 166 also may include a Non-RT RIC 168 configured to support functionality of the SMO Framework 166.

The Non-RT RIC 168 may be configured to include a logical function that enables non-real-time control of RAN elements and resources, Artificial Intelligence/Machine Learning (AI/ML) workflows including model training and updates, or policy-based guidance of applications/features in the Near-RT RIC 164. The Non-RT RIC 168 may be coupled to or communicate with (such as via an A1 interface) the Near-RT RIC 164. The Near-RT RIC 164 may be configured to include a logical function that enables near-real-time control of RAN elements and resources via data collection and actions over an interface (such as via an E2 interface) connecting one or more CUs 162, one or more DUs 170, or both, as well as an O-eNB, with the Near-RT RIC 164.

In some implementations, to generate AI/ML models to be deployed in the Near-RT RIC 164, the Non-RT RIC 168 may receive parameters or external enrichment information from external servers. Such information may be utilized by the Near-RT RIC 164 and may be received at the SMO Framework 166 or the Non-RT RIC 168 from non-network data sources or from network functions. In some examples, the Non-RT RIC 168 or the Near-RT RIC 164 may be configured to tune RAN behavior or performance. For example, the Non-RT RIC 168 may monitor long-term trends and patterns for performance and employ AI/ML models to perform remedial/corrective actions through the SMO Framework 166 (such as reconfiguration via O1) or via creation of RAN management policies (such as A1 policies).

FIG. 2 is a component block diagram illustrating an example of processor and wireless modem components 200 for use in a computing device suitable for implementing any of the various embodiments. Various embodiments may be implemented on a number of single processor and multiprocessor computer systems, including a system-on-chip (SoC) or system in a package.

With reference to FIGS. 1A-2, the illustrated example processor and wireless modem components 200 includes a two SoCs 202, 204 coupled to a clock 206, a voltage regulator 208, at least one subscriber identity module (SIM) 268 and/or a SIM interface and a wireless transceiver 266 configured to send and receive wireless communications via an antenna (not shown) to/from network wireless computing devices, such as a base station 110a. In some embodiments, the first SoC 202 operate as central processing unit (CPU) of the wireless computing device that carries out the instructions of software application programs by performing the arithmetic, logical, control and input/output (I/O) operations specified by the instructions. In some embodiments, the second SoC 204 may operate as a specialized processing unit. For example, the second SoC 204 may operate as a specialized 5G processing unit responsible for managing high volume, high speed (e.g., 5 Gbps, etc.), and/or very high frequency short wave length (e.g., 28 GHz mmWave spectrum, etc.) communications.

The first SoC 202 may include a digital signal processor (DSP) 210, a modem processor 212, a graphics processor 214, an application processor (AP) 216, one or more coprocessors 218 (e.g., vector co-processor) connected to one or more of the processors, memory 220, custom circuitry 222, system components and resources 224, an interconnection/bus module 226, one or more temperature sensors 230, a thermal management unit 232, and a thermal power envelope (TPE) component 234. The second SoC 204 may include a 5G modem processor 252, a power management unit 254, an interconnection/bus module 264, the plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SoC 202 may include a processor that executes a first type of operating system (e.g., FreeBSD, LINUX, OS X, etc.) and a processor that executes a second type of operating system (e.g., MICROSOFT WINDOWS 10). In addition, any or all of the processors 210, 212, 214, 216, 218, 252, 260 may be included as part of a processor cluster architecture (e.g., a synchronous processor cluster architecture, an asynchronous or heterogeneous processor cluster architecture, etc.).

The first and second SoC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SoC 202 may include power amplifiers, voltage regulators, oscillators, phase-locked loops, peripheral bridges, data controllers, memory controllers, system controllers, access ports, timers, and other similar components used to support the processors and software clients running on a wireless computing device. The system components and resources 224 and/or custom circuitry 222 may also include circuitry to interface with peripheral devices, such as cameras, electronic displays, wireless communication devices, external memory chips, etc.

The first and second SoC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates and/or implement a bus architecture (e.g., CoreConnect, AMBA, etc.). Communications may be provided by advanced interconnects, such as high-performance networks-on chip (NoCs).

The first and/or second SoCs 202, 204 may further include an input/output module (not illustrated) for communicating with resources external to the SoC, such as a clock 206, a voltage regulator 208, one or more wireless transceivers 266, and at least one SIM 268 and/or SIM interface (i.e., an interface for receiving one or more SIM cards). Resources external to the SoC (e.g., clock 206, voltage regulator 208) may be shared by two or more of the internal SoC processors/cores. The at least one SIM 268 (or one or more SIM cards coupled to one or more SIM interfaces) may store information supporting multiple subscriptions, including a first 5GNR subscription and a second 5GNR subscription, etc.

In addition to the example processor and wireless modem components 200 discussed above, various embodiments may be implemented in a wide variety of computing systems, which may include a single processor, multiple processors, multicore processors, or any combination thereof.

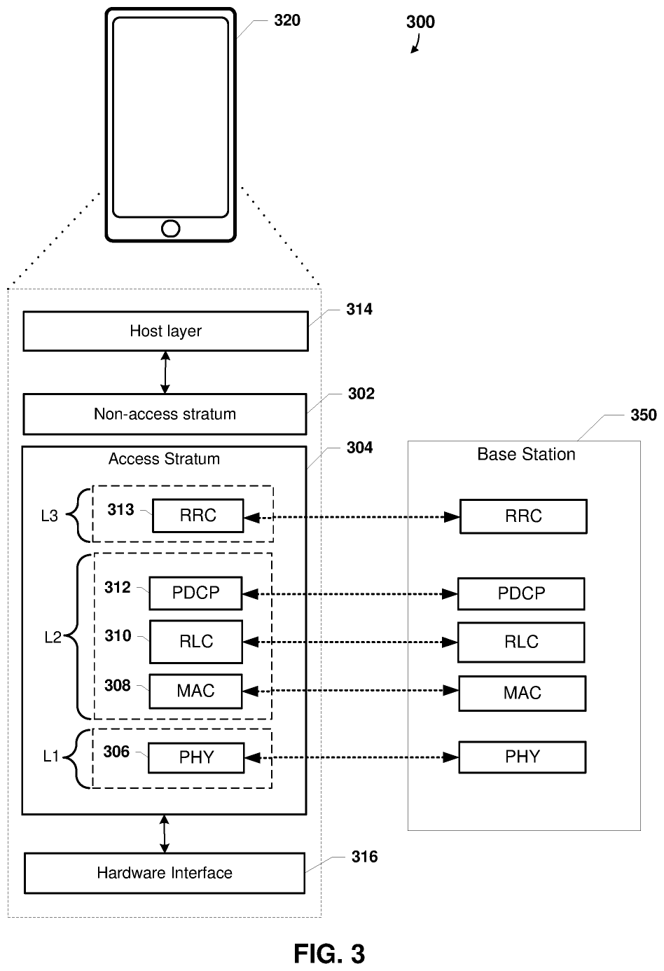

FIG. 3 is a component block diagram illustrating a software architecture 300 including a radio protocol stack for the user and control planes in wireless communications suitable for implementing any of the various embodiments. With reference to FIGS. 1-3, the wireless computing device 320 may implement the software architecture 300 to facilitate communication between a wireless computing device 320 (e.g., the wireless computing devices 120a-120e) and the base station 350 (e.g., the base station 110a-d) of a communication system (e.g., 100a, 100b). In some embodiments, layers in software architecture 300 may form logical connections with corresponding layers in software of the base station 350. The software architecture 300 may be distributed among one or more processors. While illustrated with respect to one radio protocol stack, in a multi-SIM (subscriber identity module) wireless computing device, the software architecture 300 may include multiple protocol stacks, each of which may be associated with a different SIM (e.g., two protocol stacks associated with two SIMs, respectively, in a dual-SIM wireless communication device). While described below with reference to LTE communication layers, the software architecture 300 may support any of variety of standards and protocols for wireless communications, and/or may include additional protocol stacks that support any of variety of standards and protocols wireless communications.

The software architecture 300 may include a Non-Access Stratum (NAS) 302 and an Access Stratum (AS) 304. The NAS 302 may include functions and protocols to support Packet filtering, security management, mobility control, session management, and traffic and signaling between a SIM(s) of the wireless computing device and its core network 140. The AS 304 may include functions and protocols that support communication between a SIM(s) and entities of supported access networks (e.g., a base station). In particular, the AS 304 may include at least three layers (Layer 1, Layer 2, and Layer 3), each of which may contain various sub-layers.

In the user and control planes, Layer 1 (L1) of the AS 304 may be a physical layer (PHY) 306, which may oversee functions that enable transmission and/or reception over the air interface. Examples of such physical layer 306 functions may include cyclic redundancy check (CRC) attachment, coding blocks, scrambling and descrambling, modulation and demodulation, signal measurements, MIMO, etc. The PHY layer 306 may include various logical channels, including the Physical Downlink Control Channel (PDCCH) and the Physical Downlink Shared Channel (PDSCH). As an example, the PHY layer 306 may support CSI measurements and reporting (e.g., CQI measurements and reporting).

In the user and control planes, Layer 2 (L2) of the AS 304 may be responsible for the link between the wireless computing device 320 and the base station 350 over the physical layer 306. In the various embodiments, Layer 2 may include a Media Access Control (MAC) sublayer 308, a Radio link Control (RLC) sublayer 310, and a Packet data convergence protocol (PDCP) 312 sublayer, each of which form logical connections terminating at the base station 350.

In the control plane, Layer 3 (L3) of the AS 304 may include a Radio Resource Control (RRC) sublayer 3. While not shown, the software architecture 300 may include additional Layer 3 sublayers, as well as various upper layers above Layer 3. In various embodiments, the RRC sublayer 313 may provide functions including broadcasting system information, paging, and establishing and releasing an RRC signaling connection between the wireless computing device 320 and the base station 350.

In various embodiments, the PDCP sublayer 312 may provide uplink functions including multiplexing between different Radio bearers and logical channels, sequence number addition, handover data handling, integrity protection, ciphering, and header compression. In the downlink, the PDCP sublayer 312 may provide functions that include in-sequence delivery of data packets, duplicate data Packet detection, integrity validation, deciphering, and header decompression.

In the uplink, the RLC sublayer 310 may provide segmentation and concatenation of upper layer data packets, retransmission of lost data packets, and Automatic Repeat Request (ARQ). In the downlink, while the RLC sublayer 310 functions may include reordering of data packets to compensate for out-of-order reception, reassembly of upper layer data packets, and ARQ.

In the uplink, MAC sublayer 308 may provide functions including multiplexing between logical and transport channels, random access procedure, logical channel priority, and hybrid-ARQ (HARQ) operations. In the downlink, the MAC layer functions may include channel mapping within a cell, de-multiplexing, discontinuous reception (DRX), and HARQ operations.

While the software architecture 300 may provide functions to transmit data through physical media, the software architecture 300 may further include at least one host layer 314 to provide data transfer services to various applications in the wireless computing device 320. In some embodiments, application-specific functions provided by the at least one host layer 314 may provide an interface between the software architecture and the general-purpose processor.

In other embodiments, the software architecture 300 may include one or more higher logical layer (e.g., transport, session, presentation, application, etc.) that provide host layer functions. In some embodiments, the software architecture 300 may include an application layer in which a logical connection terminates at another device (e.g., end user device, server, etc.). In some embodiments, the software architecture 300 may further include in the AS 304 a hardware interface 316 between the physical layer 306 and the communication hardware (e.g., one or more radio frequency (RF) transceivers).

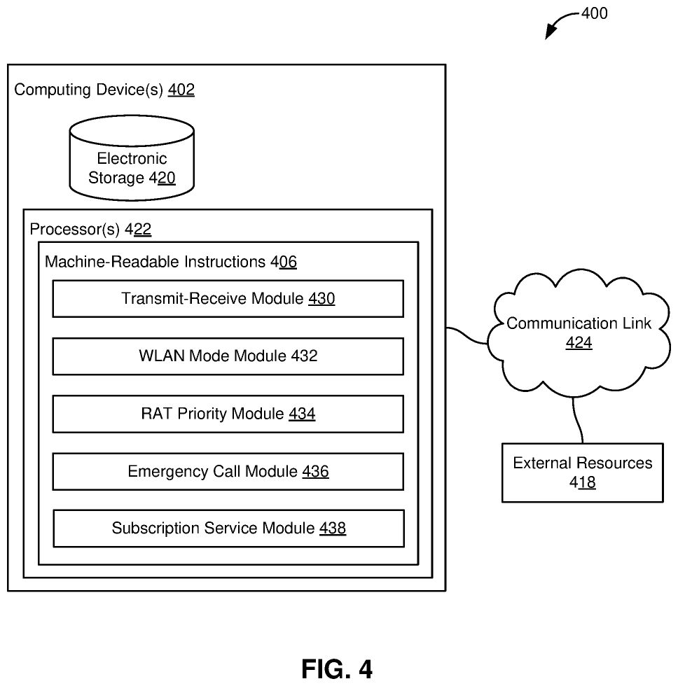

FIG. 4 is a component block diagram illustrating an example system 400 for managing RAT capability during a WLAN-only mode according to some embodiments. With reference to FIGS. 1-4, the system 400 may include one or more computing devices 402 and external resources 418, which may communicate via a wireless communication link 424. External resources 418 may include sources of information outside of the system 400, external entities participating with the system 400, or other resources. In some implementations, some or all of the functionality attributed herein to external resources 418 may be provided by resources included in the system 400. The system 400 may include a plurality of hardware, software, and/or firmware components operating together to provide the functionality attributed herein to the processor(s) 422.

The computing device 402 may include electronic storage 420 that may be configured to store information related to functions implemented by a transmit-receive module 430, a WLAN mode module 432, an RAT priority module 434, an emergency call module 436, a subscription service module 438, and any other instruction modules.

The electronic storage 420 may include non-transitory storage media that electronically stores information. The electronic storage 420 may include one or both of system storage that is provided integrally (i.e., substantially non-removable) within the processor and wireless modem components 200 (e.g., within the same SoC or SIP) and/or removable storage that is removably connectable to the processor and wireless modem components 200 via, for example, a port (e.g., a universal serial bus (USB) port, a firewire port, etc.) or a drive (e.g., a disk drive, etc.). In various embodiments, electronic storage 420 may include one or more of electrical charge-based storage media (e.g., EEPROM, RAM, etc.), solid-state storage media (e.g., flash drive, etc.), optically readable storage media (e.g., optical disks, etc.), magnetically readable storage media (e.g., magnetic tape, magnetic hard drive, floppy drive, etc.), and/or other electronically readable storage media. The electronic storage 420 may include one or more virtual storage resources (e.g., cloud storage, a virtual private network, and/or other virtual storage resources). The electronic storage 420 may store software algorithms, information determined by processor(s) 422, and/or other information that enables the processor and wireless modem components 200 to function as described herein.

The computing device 402 may be configured by machine-readable instructions 406 to perform operations of various embodiments. Machine-readable instructions 406 may include one or more instruction modules. The instruction modules may include computer program modules. The instruction modules may include one or more of the transmit-receive module 430, the WLAN mode module 432, the RAT priority module 434, the emergency call module 436, the subscription service module 438, and other instruction modules (not illustrated). The computing device 402 may include processor(s) 422 configured to implement the machine-readable instructions 406 and corresponding modules.

The processor(s) 422 may include one of more local processors that may be configured to provide information processing capabilities in the systems 100a and 100b. As such, the processor(s) 422 may include one or more of a digital processor, an analog processor, a digital circuit designed to process information, an analog circuit designed to process information, a state machine, and/or other mechanisms for electronically processing information. Although the processor(s) 422 is shown in FIG. 4 as a single entity, this is for illustrative purposes only. In some embodiments, the processor(s) 422 may include a plurality of processing units. These processing units may be physically located within the same device, or the processor(s) 422 may represent processing functionality of a plurality of devices distributed in the processor and wireless modem components 200.

In some embodiments, the processor(s) 422 executing the transmit-receive module 430 may be configured to transmit a service request with only PS RATs included in a RAT priority list to a NAS layer of the computing device.

In some embodiments, the processor(s) 422 executing the WLAN mode module 432 may be configured to determine whether the computing device is in a WLAN-only mode. In some embodiments, the processor(s) 422 executing the WLAN mode module 432 may be configured to detect a change in WLAN settings of the computing device.

In some embodiments, the processor(s) 422 executing the RAT priority module 434 may be configured to remove CS RATs from the RAT capability of the computing device in response to determining that the computing device is in the WLAN-only mode. In some embodiments, the processor(s) 422 executing the RAT priority module 434 may be configured to add the CS RATs to the RAT capability in response to determining that the computing device is in the emergency mode. In some embodiments, the processor(s) 422 executing the RAT priority module 434 may be configured to add the CS RATs to the RAT capability in response to determining that the computing device lost a communication link with subscription wireless communication service.

In some embodiments, the processor(s) 422 executing the emergency call module 436 may be configured to determine whether the computing device is in an emergency mode indicating that an emergency call has been initialized.

In some embodiments, the processor(s) 422 executing the subscription service module 438 may be configured to determine whether the computing device lost a communication link with subscription wireless communication service.

The description of the functionality provided by the different modules 430-438 is for illustrative purposes, and is not intended to be limiting, as any of modules 430-438 may provide more or less functionality than is described. For example, one or more of modules 430-438 may be eliminated, and some or all of its functionality may be provided by other ones of modules 430-438. As another example, processor(s) 422 may execute one or more additional modules that may perform some or all of the functionality attributed below to one of modules 430-438.

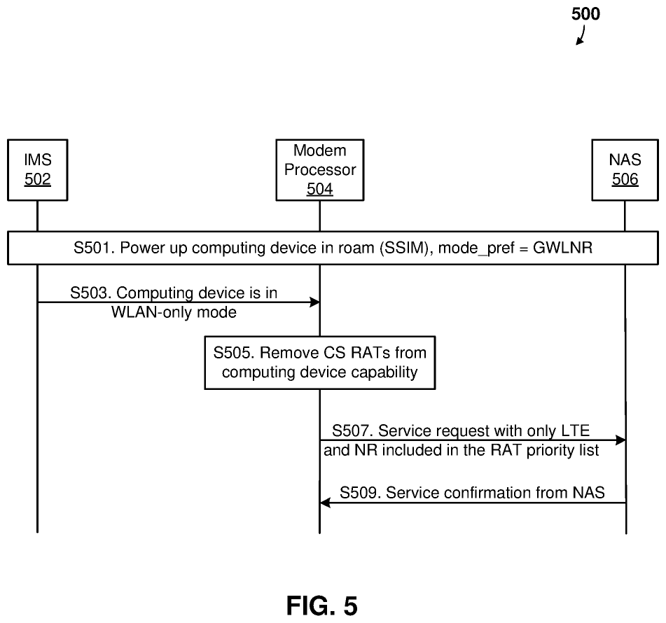

FIG. 5 is a message flow diagram 500 illustrating operations for improving modem system selection in WLAN only mode according to various embodiments. With reference to FIGS. 1A-5, a computing device (e.g., 120, 200, 320, 402) may include a modem processor 504, a multimedia subsystem 502, and a NAS 506. The modem processor 504 may be communicably coupled to the multimedia subsystem 502 and the NAS 506 to convey data and control messages between the multimedia subsystem 502 and the NAS 506. In some embodiments, the modem processor 504 may include the multimedia subsystem 502 and the NAS 506 as components and/or layers built into the modem processor 504. The modem processor 504 may be configured to operate in various network modes. For example, the modem processor 504 may operate in a multimode, in which the computing device 500 may communicate within a telecommunications network according to multiple communications standards and protocols including CS RATs and PS RATs. As another example, the modem processor 504 may operate in a WLAN-only mode, in which the computing device 500 may communicate within a telecommunications network according to communications standards and protocols including PS RATs but excluding CS RATs.

In operation 5501, the computing device may power up in a roaming configuration via a SIM or Soft SIM (i.e., software SIM, or virtual SIM). In software, a mode preference may be represented as “mode_pref=GWLNR,” which stands for GSM, WCDMA, LTE and NRSG. Upon bootup, the modem processor 504 may be configured in a default mode, or full RAT mode, in which both CS RATs and PS RATs are enabled and included within a RAT list, and in which WLAN-only mode is disabled (i.e., Wi-Fi is not preferred over CS RATs or PS RATs).

In operation 5503, the multimedia subsystem 502 may transmit a notification message to the modem processor indicating that the computing device is in a WLAN-only mode. In some embodiments, the multimedia subsystem 502 may detect whether the computing device has entered a WLAN-only mode. In some embodiments, the multimedia subsystem 502 may receive a notification message, flag, or bit measured by another component of the computing device indicating that the computing device has entered a WLAN-only mode. In some embodiments, a user of the computing device may manually configure the computing device to enter a WLAN-only mode. In some embodiments, the computing device may automatically enter a WLAN-only mode. For example, a user may enable a setting allowing for dynamic operation of the WLAN-only mode, such that the computing device may determine when, if at all, to enter a WLAN-only mode (e.g., after repeatedly reestablishing CS RAT sessions, when the battery charge state is low with weak CS/PS RAT signal strength).

In operation 5505, in response to receiving the notification message from the multimedia subsystem 502 indicating that the computing device has entered a WLAN-only mode, the modem processor 504 may remove CS RATs (e.g., GMA, CDMA, WCDMA) from the computing device RAT capability. CS RATs may be safely removed from the RAT priority list as they are not able to be implemented and are not supported during a WLAN-only mode. In other words, searching for CS RATs during a WLAN-only mode would be a waste of computational resources. Comparatively, PS RATs may be retained within the RAT priority list because PS RATs may support WLAN-only mode in various use cases. In some embodiments, removing CS RAT device capability from a computing device RAT capability may include updating a RAT priority list stored within the modem processor 504, in which the RAT priority list is modified to exclude the CS RATs.

In operation 5507, the modem processor 504 may transmit a service request including the RAT priority list to the NAS 506. As the RAT priority list was modified to exclude CS RATs, the service request may include only PS RATs (e.g., LTE and NR). Thus, any outgoing session initialization procedures to establish a connection with a network access point may exclude CS RATs invalidated by WLAN-only mode and include PS RATs that support WLAN-only mode. Reducing the number of searchable RATs may reduce the number of processes necessary to search for and initialize a session with an available network access point, therefore conserving energy stored in a battery and reducing the possibility of mobile roaming charges.

In operation 5509, the modem processor 504 may receive a service confirmation message from the NAS 506. The service confirmation message may indicate that a network session is able to be established via a Wi-Fi connection and/or one of a PS RAT connection.

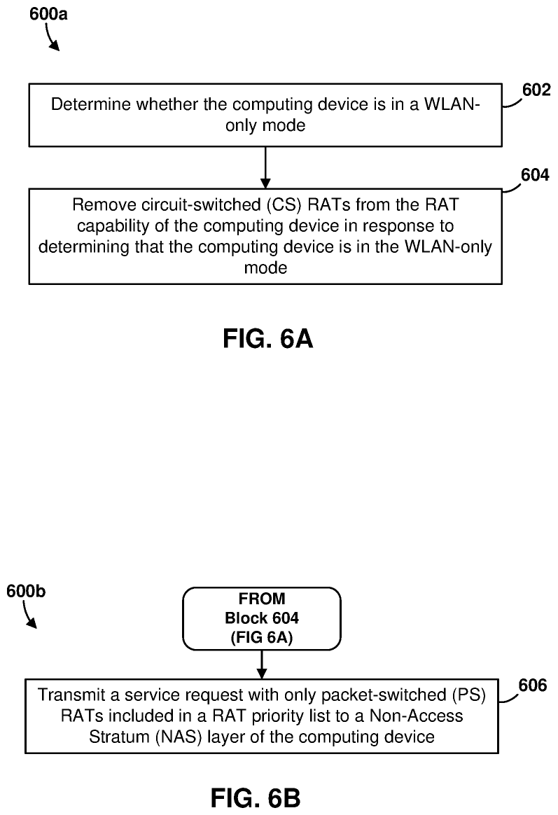

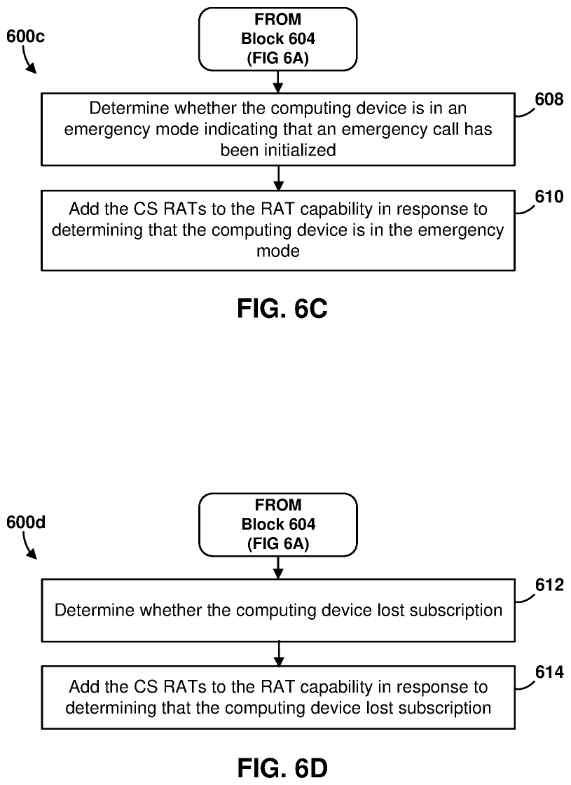

FIG. 6A is a process flow diagram of an example method 600a that may be performed by a processor of a computing device for managing RAT capability during a WLAN-only mode in accordance with various embodiments. FIGS. 6B-6D are process flow diagrams of example operations 600b-600d that may be performed as part of the method 600a as described for managing RAT capability during a WLAN-only mode in accordance with some embodiments. With reference to FIGS. 1-6D, the method 600a and the operations 600b-600d may be performed by a processor (e.g., 212, 252, 422, 504) of a computing device (e.g., 120, 200, 320, 402). In some embodiments, the processor (e.g., 212, 252, 422, 504) may be configured to perform the operations by processor-executable instruction stored in a non-transitory processor-readable medium (e.g., 220, 258, external storage 420). Means for performing each of the operations of the method 600a and the operations 600b-600d may be a processor of the systems 100a, 100b, 200, 300, 400, and 500, such as the processors 212, 252, 422, 504, and/or the like as described with reference to FIGS. 1-5.

In block 602, the processor of the computing device may perform operations including determining whether the computing device is in a WLAN-only mode. In some embodiments, determining whether the computing device is in the WLAN-only mode may include determining whether the computing device is in the WLAN-only mode during system bootup of the computing device. In some embodiments, determining whether the computing device is in the WLAN-only mode may further include receiving a notification message from a multimedia subsystem (e.g., multimedia subsystem 502) of the computing device indicating that the computing device is in the WLAN-only mode. In some embodiments, determining whether the computing device is in the WLAN-only mode may include detecting a change in WLAN settings of the computing device, and determining whether the computing device is in the WLAN-only mode in response to detecting the change in the WLAN settings. Means for performing the operations of block 602 may include a processor (e.g., 212, 252, 422, 504) of a computing device (e.g., 120, 200, 320, 402) executing the WLAN mode module 432.

In block 604, the processor of the computing device may perform operations including removing CS RATs from the RAT capability of the computing device in response to determining that the computing device is in the WLAN-only mode. Removing CS RATs from the RAT capabilities of the computing device may include removing (e.g., deleting or disabling) the CS RATs from a RAT priority list stored by or in association with a modem (e.g., modem processor 504) of the computing device, such that the RAT priority list then only includes PS RATs. Means for performing the operations of block 604 may include a processor (e.g., 212, 252, 422, 504) of a computing device (e.g., 120, 200, 320, 402) executing the RAT priority module 434.

FIG. 6B illustrates operations 600b that may be performed as part of the method 600a for managing RAT capability during a WLAN-only mode in accordance with some embodiments. With reference to FIGS. 1-6B, following the operations in block 604, the processor (e.g., 212, 252, 422, 504) of the computing device (e.g., 120, 200, 320, 402) may perform operations including transmitting a service request with only PS RATs (e.g., LTE, NR) included in a RAT priority list to a NAS (e.g., 506) layer of the computing device in block 606. In some embodiments, the RAT priority list may be included within the service request message. In some embodiments, the specific RATs identified within the RAT priority list (i.e., PS RATs during a WLAN-only mode) may be included within the service request message. Means for performing the operations of block 606 may include a processor (e.g., 212, 252, 422, 504) of a computing device (e.g., 120, 200, 320, 402) executing the transmit-receive module 430.

FIG. 6C illustrates operations 600c that may be performed as part of the method 600a for managing RAT capability during a WLAN-only mode in accordance with some embodiments. With reference to FIGS. 1-6C, following the operations in block 604, the processor (e.g., 212, 252, 422, 504) of the computing device (e.g., 120, 200, 320, 402) may perform operations including determining whether the computing device is in an emergency mode indicating that an emergency call has been initialized in block 608. Means for performing the operations of block 608 may include a processor (e.g., 212, 252, 422, 504) of a computing device (e.g., 120, 200, 320, 402) executing the emergency call module 436.

In block 610, the processor of the computing device may perform operations including adding the CS RATs to the RAT capability in response to determining that the computing device is in the emergency mode. An emergency call initialization may indicate a high priority need to ensure an emergency call session is properly established. Thus, adding the CS RATs back into the RAT priority list of the modem (e.g., modem processor 504) may increase opportunities for the computing device to establish a successful wireless communication session. Means for performing the operations of block 610 may include a processor (e.g., 212, 252, 422, 504) of a computing device (e.g., 120, 200, 320, 402) executing the RAT priority module 434.

FIG. 6D illustrates operations 600d that may be performed as part of the method 600a for managing RAT capability during a WLAN-only mode in accordance with some embodiments. With reference to FIGS. 1-6D, following the operations in block 604, the processor (e.g., 212, 252, 422, 504) of the computing device (e.g., 120, 200, 320, 402) may perform operations including determining whether the computing device lost a communication link with subscription wireless communication service in block 612. Losing a subscription wireless communication link within a WLAN-only mode may indicate that Wi-Fi signals of an available network are weak or that there is no available Wi-Fi and/or PS RAT network connections available. In that situation, the computing device should try to regain a wireless communication link with a subscription wireless network by including search procedures with a full RAT priority list. Means for performing the operations of block 612 may include a processor (e.g., 212, 252, 422, 504) of a computing device (e.g., 120, 200, 320, 402) executing the subscription service module 438.

In block 614, the processor of the computing device may perform operations including adding the CS RATs to the RAT capability in response to determining that the computing device lost a communication link with subscription wireless communication service. Means for performing the operations of block 614 may include a processor (e.g., 212, 252, 422, 504) of a computing device (e.g., 120, 200, 320, 402) executing the RAT priority module 434.

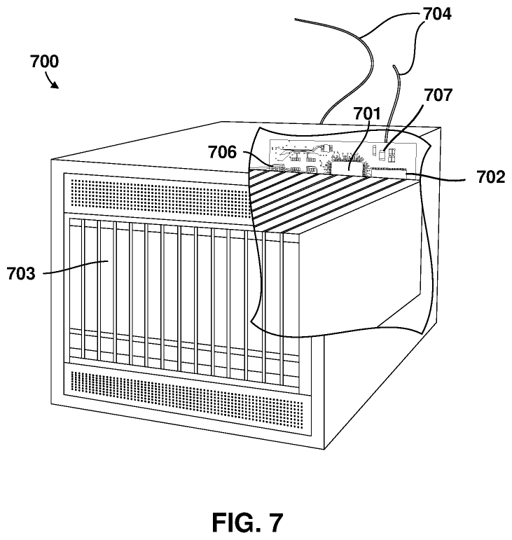

FIG. 7 is a component block diagram of a computing device 700, such as a server, suitable for use with various embodiments. Such computing devices may include at least the components illustrated in FIG. 7. With reference to FIGS. 1-7, the computing device 700 may include a processor 701 coupled to volatile memory 702 and a large capacity nonvolatile memory, such as a disk drive 703.

The computing device 700 may also include a peripheral memory access device such as a floppy disc drive, compact disc (CD) or digital video disc (DVD) drive 706 coupled to the processor 701. The computing device 700 may also include network access ports 704 (or interfaces) coupled to the processor 701 for establishing data connections with a network, such as the Internet and/or a local area network coupled to other system computers and servers.

The computing device 700 may include one or more antennas 707 for sending and receiving electromagnetic radiation that may be connected to a wireless communication link. The computing device 700 may include additional access ports, such as USB, Firewire, Thunderbolt, and the like for coupling to peripherals, external memory, or other devices.

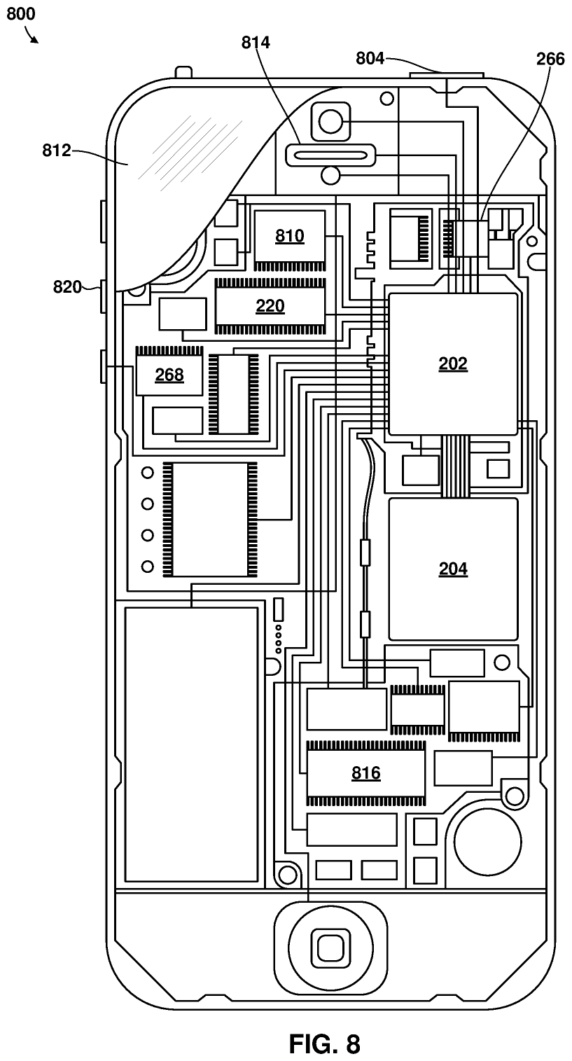

FIG. 8 is a component block diagram of a computing device 800 suitable for use with various embodiments. With reference to FIGS. 1-8, various embodiments may be implemented on a variety of computing devices 800 (e.g., 102, 200, 302, 400), an example of which is illustrated in FIG. 8 in the form of a smartphone. The computing device 800 may include a first SoC 202 (e.g., a SoC-CPU) coupled to a second SoC 204 (e.g., a 5G capable SoC). The first and second SoCs 202, 204 may be coupled to internal memory 816, a display 812, and to a speaker 814. The first and second SoCs 202, 204 may also be coupled to at least one SIM 268 and/or a SIM interface that may store information supporting a first 5GNR subscription and a second 5GNR subscription, which support service on a 5G non-standalone (NSA) network.

The computing device 800 may include an antenna 804 for sending and receiving electromagnetic radiation that may be connected to a wireless transceiver 266 coupled to one or more processors in the first and/or second SoCs 202, 204. The computing device 800 may also include menu selection buttons or rocker switches 820 for receiving user inputs.

The computing device 800 also includes a sound encoding/decoding (CODEC) circuit 810, which digitizes sound received from a microphone into data packets suitable for wireless transmission and decodes received sound data packets to generate analog signals that are provided to the speaker to generate sound. Also, one or more of the processors in the first and second SoCs 202, 204, wireless transceiver 266 and CODEC 810 may include a digital signal processor (DSP) circuit (not shown separately).

The processors of the computing device 700 and the computing device 800 may be any programmable microprocessor, microcomputer, or multiple processor chip or chips that can be configured by software instructions (applications) to perform a variety of functions, including the functions of the various embodiments described. In some mobile devices, multiple processors may be provided, such as one processor within an SoC 204 dedicated to wireless communication functions and one processor within an SoC 202 dedicated to running other applications. Software applications may be stored in memory 220, 258, 420, 703 before they are accessed and loaded into the processor. The processors may include internal memory sufficient to store the application software instructions.

Implementation examples are described in the following paragraphs. While some of the following implementation examples are described in terms of example methods, further example implementations may include: the example methods discussed in the following paragraphs implemented by a computing device including a processor configured with processor-executable instructions to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1. A method performed by a processor of a computing device for managing Radio Access Technology (RAT) capability during a Wireless Local Area Network (WLAN)-only mode, including: determining whether the computing device is in a WLAN-only mode; and removing circuit-switched (CS) RATs from the RAT capability of the computing device in response to determining that the computing device is in the WLAN-only mode.

Example 2. The method of example 1, in which determining whether the computing device is in the WLAN-only mode further includes determining whether the computing device is in the WLAN-only mode during system bootup of the computing device.

Example 3. The method of example 1, in which determining whether the computing device is in the WLAN-only mode further includes: detecting a change in WLAN settings of the computing device; and determining whether the computing device is in the WLAN-only mode in response to detecting the change in the WLAN settings.

Example 4. The method of example 1, in which determining whether the computing device is in the WLAN-only mode includes receiving a notification message from an Intellectual Property Multimedia Subsystem (multimedia subsystem) of the computing device indicating that the computing device is in the WLAN-only mode.

Example 5. The method of any of examples 1-4, further including: transmitting a service request with only packet-switched (PS) RATs included in a RAT priority list to a Non-Access Stratum (NAS) layer of the computing device, in which the PS RATs include Long Term Evolution (LTE) and New Radio (NR).

Example 6. The method of any of examples 1-5, further including: determining whether the computing device is in an emergency mode indicating that an emergency call has been initialized; and adding the CS RATs to the RAT capability in response to determining that the computing device is in the emergency mode.

Example 7. The method of any of examples 1-6, further including: determining whether the computing device lost a communication link with subscription wireless communication service; and adding the CS RATs to the RAT capability in response to determining that the computing device lost a communication link with subscription wireless communication service.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a wireless computing device and the wireless computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different cellular and mobile communication services and standards are available or contemplated in the future, all of which may implement and benefit from the various embodiments. Such services and standards include, e.g., third generation partnership project (3GPP), LTE systems, third generation wireless mobile communication technology (3G), fourth generation wireless mobile communication technology (4G), fifth generation wireless mobile communication technology (5G) as well as later generation 3GPP technology, global system for mobile communications (GSM), universal mobile telecommunications system (UMTS), 3GSM, general Packet Radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (TCUASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A computing device, comprising:
a processor configured to:
determine whether the computing device is in a Wireless Local Area Network (WLAN)-only mode; and
remove circuit-switched (CS) Radio Access Technologies (RATs) from the RAT capability of the computing device in response to determining that the computing device is in the WLAN-only mode.

2. The computing device of claim 1, wherein the processor is further configured to determine whether the computing device is in the WLAN-only mode further during system bootup of the computing device.

3. The computing device of claim 1, wherein the processor is further configured to determine whether the computing device is in the WLAN-only mode further by:
detecting a change in WLAN settings of the computing device; and
determining whether the computing device is in the WLAN-only mode in response to detecting the change in the WLAN settings.

4. The computing device of claim 1, wherein the processor is further configured to determine that the computing device is in the WLAN-only mode in response to receiving a notification message from an Intellectual Property Multimedia Subsystem (multimedia subsystem) of the computing device indicating that the computing device is in the WLAN-only mode.

5. The computing device of claim 1, wherein the processor is further configured to:
transmit a service request with only packet-switched (PS) RATs included in a RAT priority list to a Non-Access Stratum (NAS) layer of the computing device, wherein the PS RATs include Long Term Evolution (LTE) and New Radio (NR).

6. The computing device of claim 1, wherein the processor is further configured to:
determine whether the computing device is in an emergency mode indicating that an emergency call has been initialized; and
add the CS RATs to the RAT capability in response to determining that the computing device is in the emergency mode.

7. The computing device of claim 1, wherein the processor is further configured to:
determine whether the computing device lost a communication link with subscription wireless communication service; and
add the CS RATs to the RAT capability in response to determining that the computing device lost a communication link with subscription wireless communication service.

8. A method performed by a processor of a computing device for managing Radio Access Technology (RAT) capability during a Wireless Local Area Network (WLAN)-only mode, comprising:
determining whether the computing device is in a WLAN-only mode; and
removing circuit-switched (CS) RATs from the RAT capability of the computing device in response to determining that the computing device is in the WLAN-only mode.

9. The method of claim 8, wherein determining whether the computing device is in the WLAN-only mode further comprises determining whether the computing device is in the WLAN-only mode during system bootup of the computing device.

10. The method of claim 8, wherein determining whether the computing device is in the WLAN-only mode further comprises:
detecting a change in WLAN settings of the computing device; and
determining whether the computing device is in the WLAN-only mode in response to detecting the change in the WLAN settings.

11. The method of claim 8, wherein determining whether the computing device is in the WLAN-only mode comprises receiving a notification message from an Intellectual Property Multimedia Subsystem (multimedia subsystem) of the computing device indicating that the computing device is in the WLAN-only mode.

12. The method of claim 8, further comprising:
transmitting a service request with only packet-switched (PS) RATs included in a RAT priority list to a Non-Access Stratum (NAS) layer of the computing device, wherein the PS RATs include Long Term Evolution (LTE) and New Radio (NR).

13. The method of claim 8, further comprising:
determining whether the computing device is in an emergency mode indicating that an emergency call has been initialized; and
adding the CS RATs to the RAT capability in response to determining that the computing device is in the emergency mode.

14. The method of claim 8, further comprising:
determining whether the computing device lost a communication link with subscription wireless communication service; and
adding the CS RATs to the RAT capability in response to determining that the computing device lost a communication link with subscription wireless communication service.

15. A computing device, comprising:
means for determining whether the computing device is in a Wireless Local Area Network (WLAN)-only mode; and
means for removing circuit-switched (CS) Radio Access Technologies (RATs) from the RAT capability of the computing device in response to determining that the computing device is in the WLAN-only mode.

16. The computing device of claim 15, wherein means for determining whether the computing device is in the WLAN-only mode further comprises means for determining whether the computing device is in the WLAN-only mode during system bootup of the computing device.

17. The computing device of claim 15, wherein means for determining whether the computing device is in the WLAN-only mode further comprises:
means for detecting a change in WLAN settings of the computing device; and
means for determining whether the computing device is in the WLAN-only mode in response to detecting the change in the WLAN settings.

18. The computing device of claim 15, wherein means for determining whether the computing device is in the WLAN-only mode comprises means for receiving a notification message from an Intellectual Property Multimedia Subsystem (multimedia subsystem) of the computing device indicating that the computing device is in the WLAN-only mode.

19. The computing device of claim 15, further comprising:
means for transmitting a service request with only packet-switched (PS) RATs included in a RAT priority list to a Non-Access Stratum (NAS) layer of the computing device, wherein the PS RATs include Long Term Evolution (LTE) and New Radio (NR).

20. The computing device of claim 15, further comprising:
means for determining whether the computing device is in an emergency mode indicating that an emergency call has been initialized; and
means for adding the CS RATs to the RAT capability in response to determining that the computing device is in the emergency mode.

21. The computing device of claim 15, further comprising:
means for determining whether the computing device lost a communication link with subscription wireless communication service; and
means for adding the CS RATs to the RAT capability in response to determining that the computing device lost a communication link with subscription wireless communication service.

22. A non-transitory processor-readable medium having stored thereon configured to cause a processor of a computing device to perform operations comprising:
determining whether the computing device is in a Wireless Local Area Network (WLAN)-only mode; and
removing circuit-switched (CS) Radio Access Technologies (RATs) from the RAT capability of the computing device in response to determining that the computing device is in the WLAN-only mode.

23. The non-transitory processor-readable medium of claim 22, wherein the stored processor-executable instructions are configured to cause the processor to perform operations such that determining whether the computing device is in the WLAN-only mode further comprises determining whether the computing device is in the WLAN-only mode during system bootup of the computing device.

24. The non-transitory processor-readable medium of claim 22, wherein the stored processor-executable instructions are configured to cause the processor to perform operations such that determining whether the computing device is in the WLAN-only mode further comprises:
detecting a change in WLAN settings of the computing device; and
determining whether the computing device is in the WLAN-only mode in response to detecting the change in the WLAN settings.

25. The non-transitory processor-readable medium of claim 22, wherein the stored processor-executable instructions are configured to cause the processor to perform operations such that determining whether the computing device is in the WLAN-only mode comprises receiving a notification message from an Intellectual Property Multimedia Subsystem (multimedia subsystem) of the computing device indicating that the computing device is in the WLAN-only mode.

26. The non-transitory processor-readable medium of claim 22, wherein the stored processor-executable instructions are configured to cause the processor to perform operations further comprising:
transmitting a service request with only packet-switched (PS) RATs included in a RAT priority list to a Non-Access Stratum (NAS) layer of the computing device, wherein the PS RATs include Long Term Evolution (LTE) and New Radio (NR).

27. The non-transitory processor-readable medium of claim 22, wherein the stored processor-executable instructions are configured to cause the processor to perform operations further comprising:
determining whether the computing device is in an emergency mode indicating that an emergency call has been initialized; and
adding the CS RATs to the RAT capability in response to determining that the computing device is in the emergency mode.

28. The non-transitory processor-readable medium of claim 22, wherein the stored processor-executable instructions are configured to cause the processor to perform operations further comprising:
determining whether the computing device lost a communication link with subscription wireless communication service; and
adding the CS RATs to the RAT capability in response to determining that the computing device lost a communication link with subscription wireless communication service.
